(19) United States
(12) Patent Application Publication
(10) Pub. No.: US 2009/0055850 A1
(43) Pub. Date: Feb. 26, 2009

(54) Optical Disk Drive

(76) Inventor: Hung-Chi Teng, Taichung City (TW)

Correspondence Address: HDLS Patent & Trademark Services, P.O. BOX 220746, CHANTILLY, VA, 20153-0746, US

(21) Appl. No.: 11/843,888

(22) Filed: Aug. 23, 2007

(51) Int. Cl. G11B 7/08

(52) U.S. Cl. 720/674

(57) ABSTRACT

An optical disc drive includes a locking part, a transmission-compensation mechanism, and a horizontal adjustment mechanism. The locking part is used to secure the first chucking portion and the second chucking portion of the disc chucker to the chucker seat. Therefore, the disc chucker keeps the optical disc stably. Besides, the transmission-compensation mechanism makes power of the driving motor be precisely transmitted to the optical pickup head. This effectively eliminates error or distortion during reading the optical disc. Furthermore, the horizontal adjustment mechanism is adopted to easily and efficiently regulate the angle between the optical disc and the optical pickup head.

### BACKGROUND

The present invention relates to optical disc drives, and more particularly to, an optical disc drive that is easy to assemble and works stably.

A present optical disc drive uses a spindle motor to drive an optical disc to rotate, and uses a feeding motor and a transmission mechanism to drive an optical pickup head to move, so as to read information on the optical disc. However, the present optical disc drive has the following problems:

1. In the present transmission mechanism, the engagement between the screw rod and the gear rack is not always in a good condition, which leads to wearing problems in the transmission mechanism, produces noise during its operation and sometimes even degrades the reading performance of the optical disc drive.

2. In an ideal condition, an angle between the optical disc and the laser beam emitted from the optical pickup head is 90 degrees while 10 minutes of tolerance of error is allowed for normal operation. However, due to problems with the conventional mechanism, in assembly of the optical disc drive, the angle between the optical disc and the laser beam is often not within the allowable range. Therefore, the angle of the optical pickup head should be adjusted to fulfill the requirement. Usually, the optical pickup head is mounted on a pair of guide rails, so a horizontal angle of the guide rails are adjusted to change the angle of the optical pickup head relative to the optical disc. To do so, many components need to be adjusted and it is relatively time consuming. As a result, the cost and the time for mass production are increased.

3. The conventional disc chucker of the optical disc drive is easy to be loosened after the manufacturing and assembly process due to problems with the conventional mechanism. This may cause the optical disc not steadily and centrically chucked and hence degrade the performance of the optical pickup head in reading an optical disc.

Therefore, the present invention successfully resolves the above problems after long time extensive research and development.

### BRIEF SUMMARY

What is needed, therefore, is to provide an optical disk drive with a driving device, which drives an optical pickup head and includes a transmission-compensation mechanism. The transmission-compensation mechanism precisely transmits power to the optical pickup head due to no looseness of the transmission mechanism.

What is needed, therefore, is to provide an optical disk drive with a disc chucker, which includes a locking portion to exactly position the disc.

What is needed, therefore, is to provide an optical disk drive with a horizontal adjustment mechanism for a spindle motor thereon, which causes to save time and easily regulate an angle between the optical pickup head and the disc due to utilization of horizontal adjustment mechanism.

An object and effect of the present invention is carried out through the following technology means.

The present invention is to provide an optical disc drive including: an optical pickup head driven by a driving device and slidably mounted on a pair of guide rails, the driving device including a driving motor and a transmission-compensation mechanism, the transmission-compensation mechanism including a screw rod and a rack member, the screw rod being connected to the driving motor and rotatable under the driving of the driving motor, the rack member being disposed at one side of the optical pickup head, the rack member including a rack seat and a rack bracket formed along a radial direction of the screw rod, the rack member forming a rack in mesh with the screw rod along an axial direction of the screw rod, and the rack bracket and the rack being made of a resilient material and being combined by an integrated molding process; a spindle motor configured for driving an optical disc, the spindle motor including a fixing plate; a base plate configured for mounting the optical pickup head and the spindle motor thereon, the base plate being mounted on a lifting frame; a horizontal adjustment mechanism disposed between the base plate and the fixing plate of the spindle motor to regulate an angle between the optical disc on the spindle motor and the optical pickup head; a tray device including a tray, a loading motor configured for driving the tray, and a transmission mechanism connecting the tray and the transmission mechanism, the tray being moveable in and out of the loading chassis under the driving of the loading motor; a disc chucker secured to a chucker base corresponding to the spindle motor, the disc chucker being mounted on the loading chassis via the chucker seat, the disc chucker including a first chucking portion, a second chucking portion, a locking portion, and at least one magnet, the first chucking portion having a first plate body with a first surface and a second surface, the first plate body defining a recess towards the first surface, with an opening end of the recess facing the second surface, the first plate body further defining a plurality of arc slots throughout the first surface and the second surface, the second chucking portion including a second plate body with a third surface and a fourth surface, the fourth surface of the second plate body forming a circular protrusion thereon, the locking portion including a bevel part and a hook part, the bevel part being formed in the arc slot, the hook part being formed around and higher than the circular protrusion, the magnet being positioned in the recess, the recess of the first chucking portion being received in the circular protrusion through an opening in the chucker seat, the hook part of the locking portion being received in the arc slot and rotatable along the bevel part at a certain angle to make the hook part press on the bevel part, and the chucker seat being firmly clamped between the first chucking portion and the second chucking portion; and a loading chassis configured for mounting the above components thereon.

Comparing with a conventional technology, the optical disk drive of the present invention provides a compact transmission mechanism, a disc chucker for precisely positioning an optical disc thereon, a horizontal adjustment mechanism being configured for easily and quickly regulating an inclination angle of the optical disc relative to the optical pickup head. Thus, the optical pickup head of the optical disk drive is prone to accurately reading the optical disc. Furthermore, it is suitable for mass production.

Other advantages and novel features will be drawn from the following detailed description of preferred embodiment with the attached drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is an isometric view of an optical disc drive according to a preferred embodiment of the present invention;

FIG. 2 is a partially exploded view of the optical disc drive of FIG. 1;

FIG. 3 is a view of an assembly of the optical pickup head, the spindle motor, and the transmission-compensation mechanism, and the base plate;

FIG. 4 is an isometric view of the rack seat in the optical disc drive of FIG. 1;

FIG. 5 is an exploded view of the spindle motor, the horizontal adjustment mechanism, and the base plate;

FIG. 6 is a right-side elevational view of FIG. 3;

FIG. 7 is a side elevational view of an assembly of the optical pickup head, the spindle motor, the disc chucker, and the optical disc;

FIG. 8 is an exploded view of the disc chucker;

FIG. 9 is an assembled view of the disc chucker of FIG. 8;

FIG. 10 is a top eleational view of the disc chucker before assembled;

FIG. 11 is a top eleational view of the disc chucker after assembled;

FIG. 12 is a partially cut-off view of the disc chucker of FIG. 10;

FIG. 13 is a partially cut-off view of the disc chucker of FIG. 11; and

FIG. 14 is a cross-sectional view of the disc chucker of FIG. 11, taken along line A-A.

### DETAILED DESCRIPTION

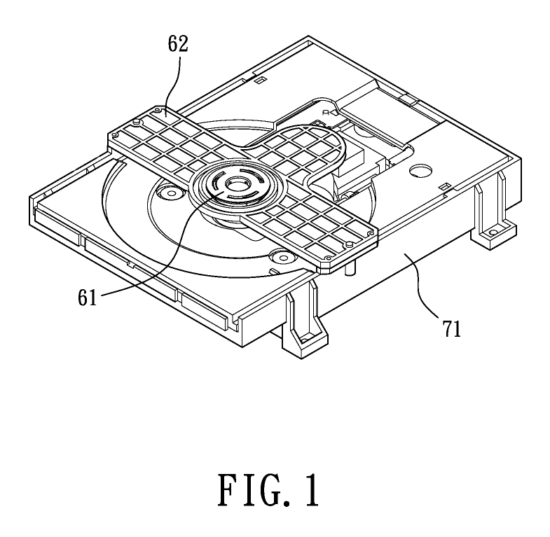

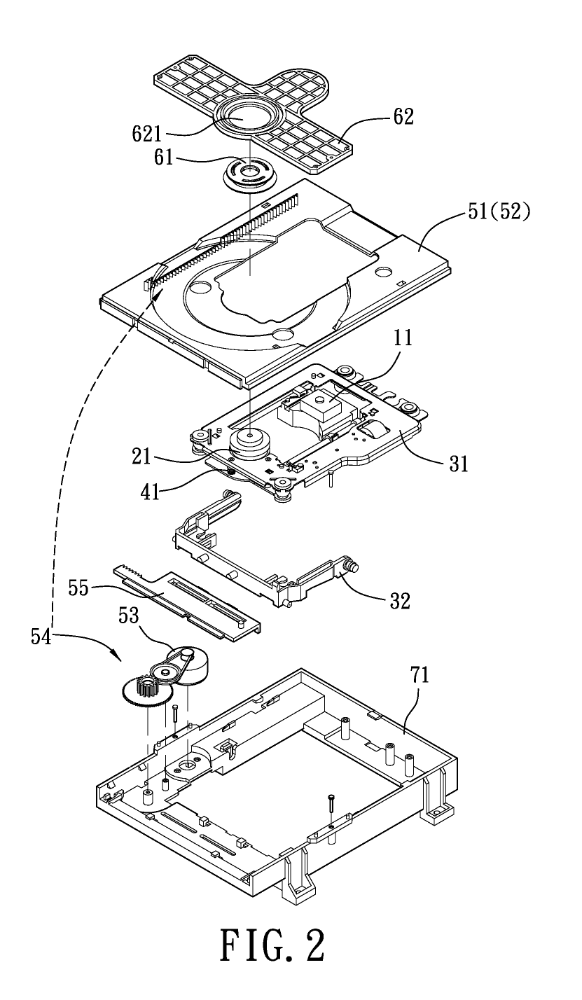

Referring to FIGS. 1-2, in the preferred embodiment, an optical disc drive mainly includes an optical pickup head 11, a spindle motor 21, a base plate 31, a horizontal adjustment mechanism 41, a tray device 51, a disc chucker 61, and a loading chassis 71.

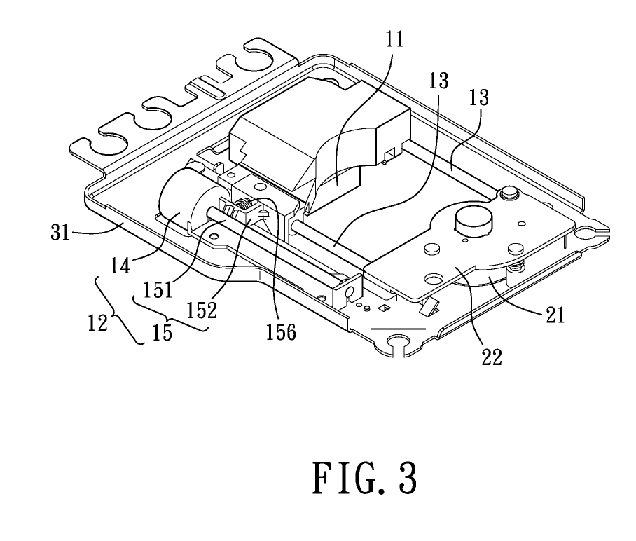

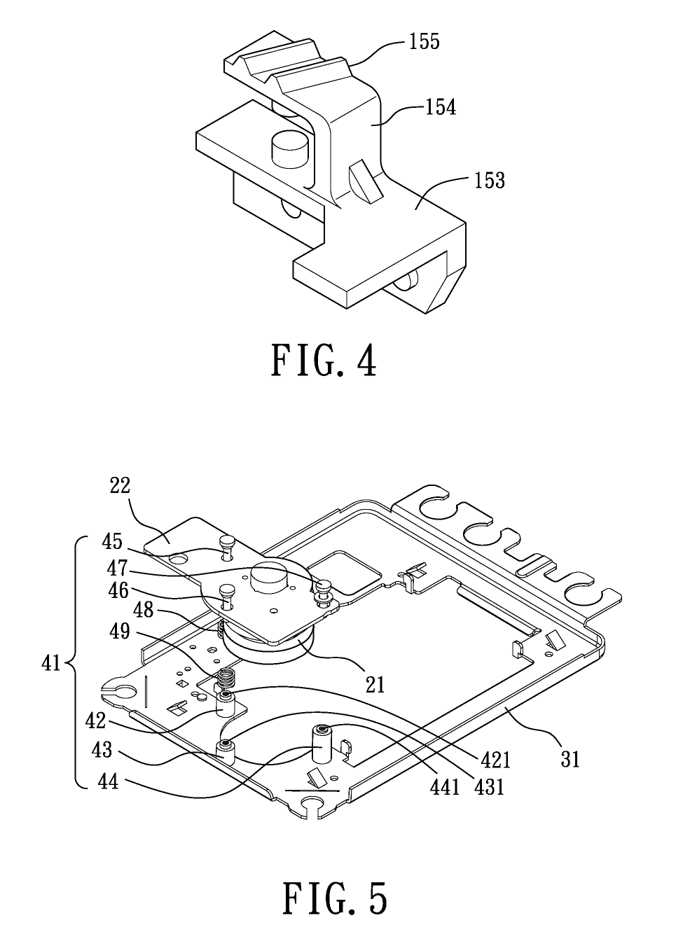

Referring to FIGS. 3-4, the optical pickup head 11 is driven by a driving device 12, and is slidably mounted on a pair of guide rails 13. The driving device 12 includes a driving motor 14, and a transmission-compensation mechanism 15 connecting the driving motor 14 and the optical pickup head 11. The transmission-compensation mechanism 15 includes a screw rod 151 and a rack member 152. The screw rod 151 is connected to an output terminal of the driving motor 14, and is rotated via the driving of the driving motor 14. The rack member 152 is secured to a lateral side of the optical pickup head 11, and includes a rack seat 153 and a rack bracket 154. The rack bracket 154 is formed along a radial direction of the screw rod 151, and transversely forms a rack 155 in mesh with the screw rod 151 along an axial direction of the screw rod 151. The rack bracket 154 and the rack 155 are made of a resilient material, for example a plastic material by integrative molding. A spring 156 is sandwiched between the rack seat 153 and the rack 155.

As shown in FIGS. 2-3, the spindle motor 21 is a major driving source of the optical disc. The spindle motor 21 includes a fixing plate 22 for securing the spindle motor 21 to the base plate 31 of the optical disc drive.

The base plate 31 is configured for mounting the optical pickup head 11, the spindle motor 21 thereon. The base plate 31 is connected to a lifting frame 32.

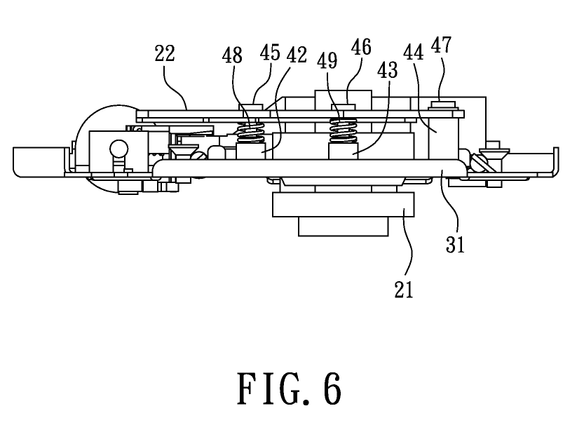

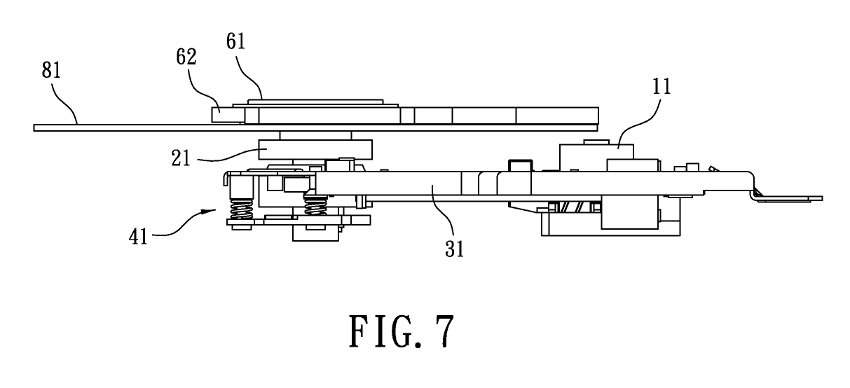

Referring to FIGS. 3, and 5-7, the horizontal adjustment mechanism 41 is located between the base plate 31 and the fixing plate 22 for adjusting an angle between an optical disc 81 on the spindle motor 21 and the optical pickup head 11. The horizontal adjustment mechanism 41 includes a first post 42, a second post 43, a third post 44, a first adjusting screw rod 45, a second adjusting screw rod 46, and a fixing screw rod 47. The first, second, and third posts 42, 43, 44 extends from the base plate 31 in a triangle pattern. The first, second, and third posts 42, 43, 44 each defines a thread hole 421, 431, 441 therein. A height of the third post 44 is greater than those of the first and second posts 42, 43. The fixing screw rod 47 locks the fixing plate 22 to the third post 44. The first adjusting screw rod 45 extends through the fixing plate 22 to screw to the first post 42. A first spring 48 is disposed on the first adjusting screw rod 45 and located between the fixing plate 22 and the first post 42. The second adjusting screw rod 46 extends through the fixing plate 22 to screw to the second post 43. A second spring 49 is disposed on the first adjusting screw rod 46 and located between the fixing plate 22 and the second post 43.

Referring to FIG. 1-2, the tray device 51 includes a tray 52, a loading motor 53 for driving the tray 52, and a transmission mechanism 54 connecting the tray 52 and the loading motor 53. The tray 52 is moveable inside a loading chassis 71 or outside the loading chassis 71 via the driving of the loading motor 53. A connecting mechanism 55 is connected to the lifting frame 32 to make the lifting frame 32 be lifted or lowered when the tray 52 moves into or out from the loading chassis 71. The base plate 31 connected to the lifting frame 32 can be lifted or lowered together with the lifting frame 32.

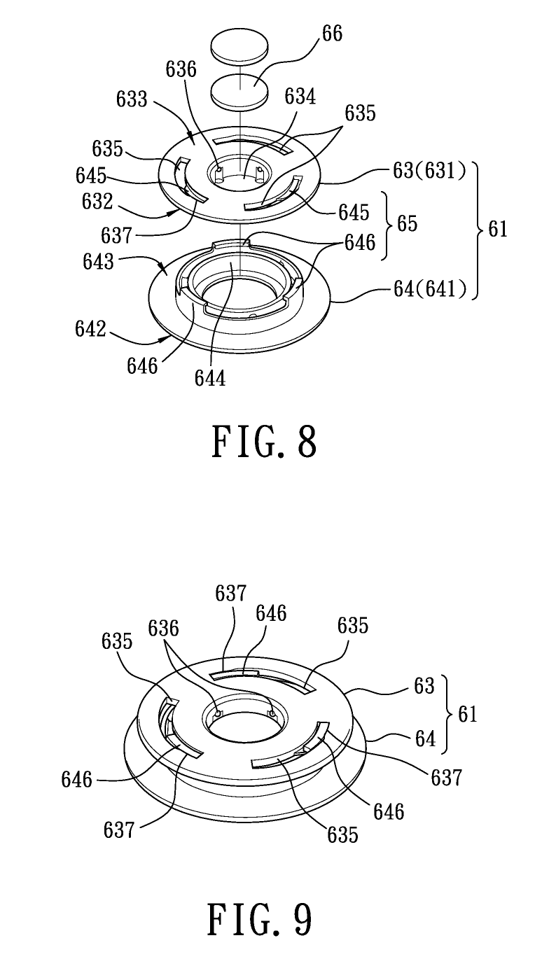

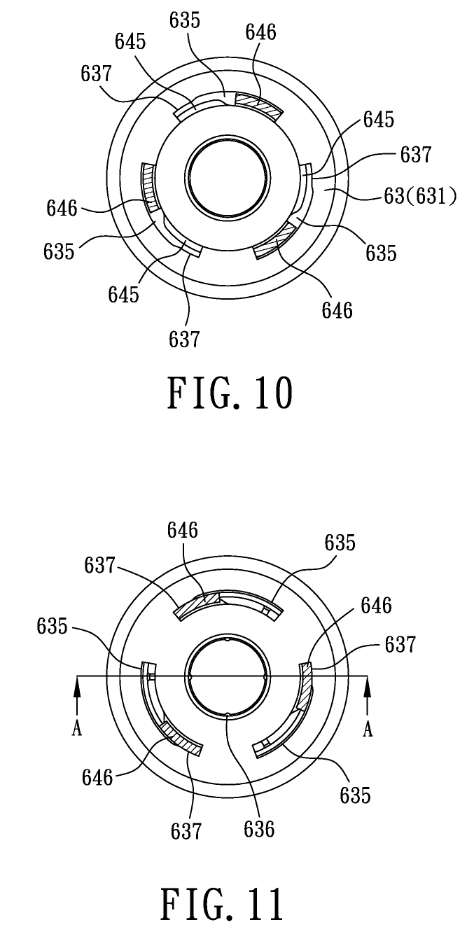

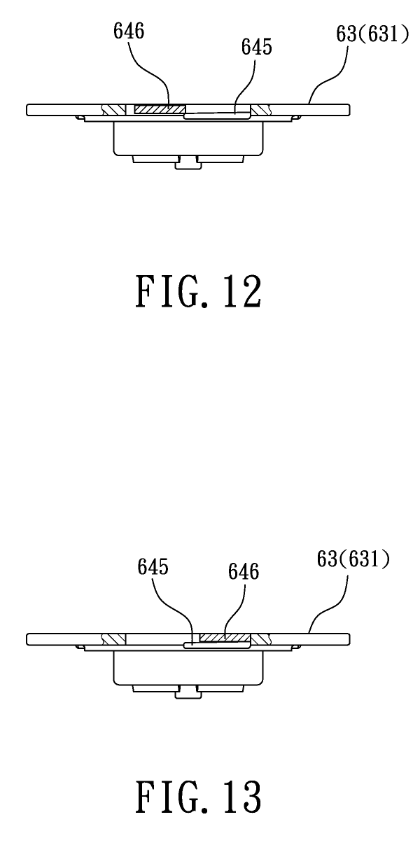

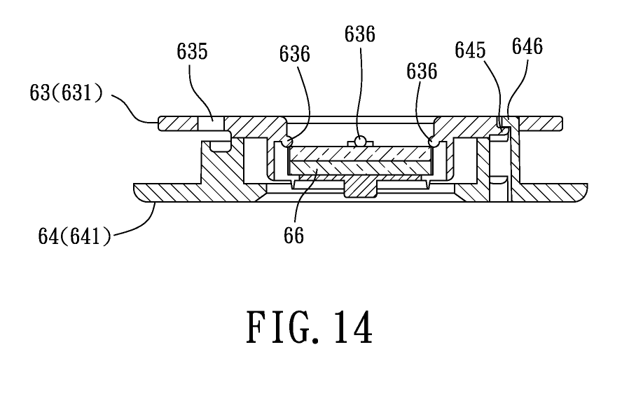

Referring to FIGS. 1-2 and 7-14, the disc chucker 61 is mounted on a chucker seat 62, corresponding to the spindle motor 21. The disc chucker 61 is secured to the loading chassis 71 via the chucker seat 62. The disc chucker 61 includes a first chucking portion 62, a second chucking portion 64, a locking portion 65, and at least one magnet 66. The first chucking portion 63 forms a first plate body 631 with a first surface 632 and a second surface 633. The first plate body 631 defines a recess 634 towards the first surface 632, with an opening end of the recess 634 facing the second surface 633. The first plate body 631 further defines a plurality of arc slots 635 throughout the first surface 642 and the second surface 643. The second chucking portion 64 includes a second plate body 641 having a first surface 642 and a second surface 643. The second surface 643 of the second plate body 641 forms a circular protrusion 644 thereon. The locking portion 65 includes a bevel part 645 and a hook part 646. The bevel part 645 is formed in the arc slot 635. The hook part 646 is formed around the circular protrusion 644 of the second chucking portion 64 and higher than the circular protrusion 644.

When assembling, the magnetic 66 is positioned in the recess 634, and a plurality of restriction elements 636 is formed in an inner side of the recess 634 to hold the magnet 66 in the recess 634. The recess 634 of the first chucking portion 63 extends through an opening 621 in the chucker seat 62 and is then received in the circular protrusion 644. The hook part 646 of the locking portion 65 is received in the arc slot 635, and is rotated along the bevel part 645 at a certain angle to cause the hook part 646 to firmly press on the bevel part 645. The chucker seat 62 is thus firmly clamped between the first chucking portion 63 and the second chucking portion 64.

Further, a protruding element is formed at a distal end of each of the arc slots 635 to restrain and secure the hook part 646.

Referring back to figurers 1-2, the loading chassis 71 is used for mounting the components as described above.

In the current embodiment, the locking part 65 is used to secure the first and second chucking portions 63, 64 of the disc chucker 61 to the chucker seat 62. Therefore, the disc chucker 61 keeps the optical disc 81 stably. Besides, the transmission-compensation mechanism 15 precisely transmits power of the driving motor 14 to the optical pickup head 11 due to no looseness of the transmission mechanism. This effectively eliminates error or distortion during reading the optical disc 81. Furthermore, the horizontal adjustment mechanism 41 is adopted to easily and efficiently regulate the angle between the optical disc 81 and the optical pickup head 11.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An optical disc drive, comprising:
an optical pickup head driven by a driving device and slidably mounted on a pair of guide rails, the driving device including a driving motor and a transmission-compensation mechanism, the transmission-compensation mechanism including a screw rod and a rack member, the screw rod being connected to the driving motor and rotatable under the driving of the driving motor, the rack member being disposed at one side of the optical pickup head, the rack member including a rack seat and a rack bracket formed along a radial direction of the screw rod, the rack member forming a rack in mesh with the screw rod along an axial direction of the screw rod, and the rack bracket and the rack being made of a resilient material and being combined by an integrated molding process;
a spindle motor configured for driving an optical disc, the spindle motor including a fixing plate;
a base plate configured for mounting the optical pickup head and the spindle motor thereon, the base plate being mounted on a lifting frame;
a horizontal adjustment mechanism disposed between the base plate and the fixing plate of the spindle motor to regulate an angle between the optical disc on the spindle motor and the optical pickup head;
a tray device including a tray, a loading motor configured for driving the tray, and a transmission mechanism connecting the tray and the transmission mechanism, the tray being moveable in and out of the loading chassis under the driving of the loading motor;
a disc chucker secured to a chucker base corresponding to the spindle motor, the disc chucker being mounted on the loading chassis via the chucker seat, the disc chucker including a first chucking portion, a second chucking portion, a locking portion, and at least one magnet, the first chucking portion having a first plate body with a first surface and a second surface, the first plate body defining a recess towards the first surface, with an opening end of the recess facing the second surface, the first plate body further defining a plurality of arc slots throughout the first surface and the second surface, the second chucking portion including a second plate body with a third surface and a fourth surface, the fourth surface of the second plate body forming a circular protrusion thereon, the locking portion including a bevel part and a hook part, the bevel part being formed in the arc slot, the hook part being formed around and higher than the circular protrusion, the magnet being positioned in the recess, the recess of the first chucking portion being received in the circular protrusion through an opening in the chucker seat, the hook part of the locking portion being received in the arc slot and rotatable along the bevel part at a certain angle to make the hook part press on the bevel part, and the chucker seat being firmly clamped between the first chucking portion and the second chucking portion; and
a loading chassis configured for mounting the above components thereon.

2. The optical disc drive as set forth in claim 1, wherein the horizontal adjustment mechanism comprises:
a first post supported on the base plate, defining a thread hole therein;
a second post supported on the base plate, defining a thread hole therein;
a third post supported on the base plate, defining a thread hole therein, a height of the third post being greater than those of the first and second posts, and the first, second, and third posts being arranged in a triangle pattern;
a fixing screw rod configured for securing the fixing plate of the spindle motor to the third post;
a first adjusting screw rod screwed in the first post through the fixing plate, a first spring being disposed on the first adjusting screw rod and located between the fixing plate and the first post; and
a second adjusting screw rod screwed in the second post through the fixing plate, a second spring being disposed on the second adjusting screw rod and located between the fixing plate and the second post.

3. The optical disc drive as set forth in claim 1, wherein a protruding element is formed at a distal end of each of the arc slots of the first chucking portion.
